(19) United States
(12) Patent Application Publication
(10) Pub. No.: US 2009/0172378 A1
(43) Pub. Date: Jul. 2, 2009

(54) METHOD AND SYSTEM FOR USING A TRUSTED DISK DRIVE AND ALTERNATE MASTER BOOT RECORD FOR INTEGRITY SERVICES DURING THE BOOT OF A COMPUTING PLATFORM

(76) Inventors: Gregory J. Kazmierczak, Belle Mead, NJ (US); Leonard S. Veil, Los Gatos, CA (US); Steven K. Sprague, Richmond, MA (US)

Correspondence Address: BAKER BOTTS L.L.P., 30 ROCKEFELLER PLAZA, 44TH FLOOR, NEW YORK, NY, 10112-4498, US

(21) Appl. No.: 11/966,316

(22) Filed: Dec. 28, 2007

(51) Int. Cl. G06F 15/177

(52) U.S. Cl. 713/2

(57) ABSTRACT

A trusted hard disk drive (“THDD”) contains cryptographic primitives and support functions in a trusted partition (“TP”). In particular, a master boot record (“MBR”) of the THDD is replaced with an alternative MBR and the normal MBR is stored elsewhere on the THDD. The program(s) loaded from the alternative MBR performs measurements of the TP. The TP, in turn, performs all necessary measurements of the MBR, a personal computer platform's OS, and the OS-present applications, including a platform trust service (“PTS”) kernel. The program(s) also performs functions to clear the PC platform's state such that any events that occurred prior to its execution do not alter the functionality of the OS-present applications. This may include clearing the PC's microprocessor, system memory and cache, for example. DRTM types of system resets may also be performed after the PC's OS has booted to force system clears without requiring OS or VMM infrastructure.

### BACKGROUND OF THE INVENTION

The Trusted Computing Group (“TCG”) has created specifications and standards that describe how to measure and verify the trustworthiness of a computing platform with the assistance of a Trusted Platform Module (“TPM”) and accompanying BIOS code, which is rooted in the core root of trust for measurement (“CRTM”). Familiarity with the TCG's “trusted computing” specifications, which are incorporated herein by reference, is assumed.

The TPM stores, protects, and reports various measurements of the PC's integrity. The TPM also generates and stores cryptographic keys (for example, a public/private key pair) that may be used to authenticate those integrity measurements using, for example, digital signature and verification.

According to the TCG standards, various metrics may be utilized to characterize the integrity or trustworthiness of a particular PC. For example, every operating system (“OS”) platform includes a set of device drivers, executables, and other software components. A measurement (such as a hash digest) of the OS components when the OS is in a trusted state (e.g., such as when the OS is first installed on the PC) may function as an integrity metric, since comparison of that trusted measurement with a measurement taken at some later point in time would indicate whether the OS components had been altered or changed in some way. In fact, any hash digest of the PC's software configuration may potentially be used as a measurement to later verify the integrity of that configuration.

One way that the integrity of a PC's computing platform may be verified is by use of a transitive chain of trust. This is an iterative process that begins with a root of trust established in the PC that is capable of describing a trustworthy state of a second group of measurement functions. Based on this description, a verifier may determine the level of trust that it will place in this second group of functions. If the verifier determines this second group of functions to have an acceptable level of trustworthiness, then the trust boundary is extended from the root of trust to include the second group of functions. The now-trusted second group of functions may now be utilized to describe a trustworthy state of a third group of functions, which extends the trust boundary to the third group of functions, and so on.

The transitive trust model may be applied to measuring the integrity or trustworthiness of the components of a PC. The TCG's trusted computing standard currently describes two models for doing so: static root of trust for measurement (“SRTM”) and dynamic root of trust for measurement (“DRTM”). The SRTM model uses a well-known starting state, such as the PC's power-on BIOS boot block, as a CRTM. In SRTM, measurement must occur at the actual boot time of the PC, and thus occurs only a single time for each boot of the platform. The DRTM model begins with an un-trusted state prior to initiation of its CRTM, and transitions to a trusted state. In DRTM, measurement may occur at any time after the boot of the PC, and can occur more than once.

One problem with current implementations of SRTM and DRTM is that measurement of code integrity is terminated after the initial program loader (“IPL”) has been measured, i.e. at the point at which the OS is booted. Current implementations of SRTM and DRTM do not perform platform state measurement of the OS or of any OS-present applications, and thus the transitive trust chain is broken and a subsequent of functions cannot be trusted. While a new secondary root of trust can be created after the OS loads, there is no way to be certain that the new root of trust has not been compromised if the OS has not been measured. Another problem with current implementations of SRTM and DRTM is that not all PC platforms utilize a BIOS that is able to take advantage of the CRTM.

### SUMMARY OF THE INVENTION

In accordance with an illustrative embodiment of the present invention, a trusted hard disk drive (“THDD”) contains cryptographic primitives and support functions including an alternative master boot record (“ALT-MBR”). The ALT-MBR performs all necessary measurements of the trusted platform (“TP”). The TP, in turn, performs all necessary measurements of the master boot record (“MBR”), a personal computer platform's OS, and the OS-present applications, including a platform trust service (“PTS”) kernel. The PTS kernel subsequently performs the measurement functions to allow the transitive trust chain to continue.

The ALT-MBR also performs functions to clear the PC platform's state such that any events that occurred prior to its execution will not alter the functionality of the OS-present applications. These functions may, for example, include clearing the PC's microprocessor, system memory and cache. In accordance with an illustrative embodiment of the present invention, DRTM types of system resets such as, but not limited to, those performed using Intel's® LaGrande™ technology, may be performed after the PC's OS has booted to force system clears to return the PC platform to a trusted state. Advantageously, the invention can operate within SRTM or DRTM models.

### BRIEF DESCRIPTION OF THE DRAWINGS

FIG. 1 is a block diagram depicting a PC platform in accordance with an illustrative embodiment of the present invention;

FIG. 2 is block diagram depicting portions of a trusted hard disk drive in accordance with an illustrative embodiment of the present invention; and

FIG. 3 is a flow chart depicting a method for verifying integrity using a trusted hard disk drive in accordance with an illustrative embodiment of the present invention.

### DETAILED DESCRIPTION OF THE INVENTION

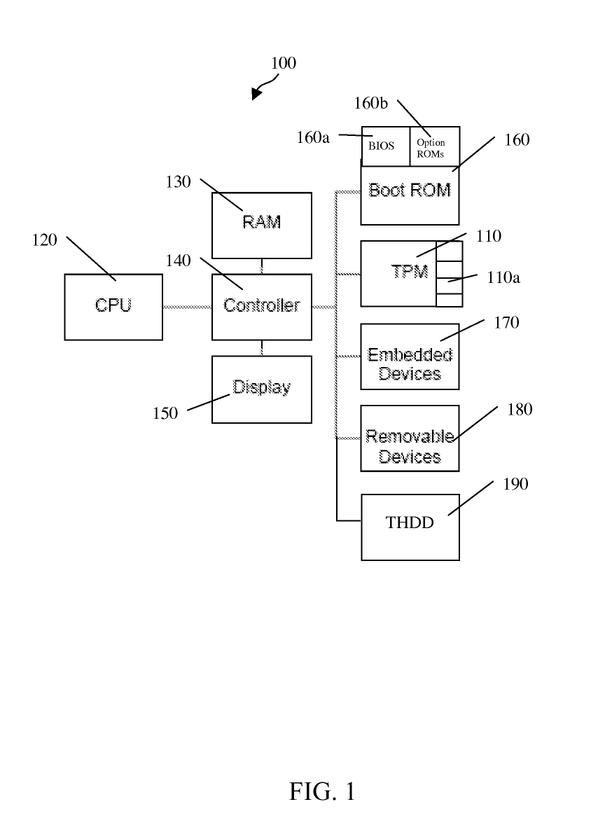

In accordance with an illustrative embodiment of the present invention, FIG. 1 is a block diagram depicting a PC platform 100 containing a trusted portion of hardware or software. In one embodiment of the present invention, the trusted portion preferably contains a trusted platform module (“TPM”) 110. However, it should be appreciated that the trusted portion may be any other suitable trusted hardware or software, such as, but not limited to, a smart card cryptographically bound to platform 100, or software that is trusted inherently (because it is isolated) or by inference (because it is measured) such as extensible firmware interface (“EFI”) software, system management mode (“SMM”) software, ACPI machine language (“AML”), etc.

PC platform 100 includes a central processing unit (“CPU”) 120 that is directly or indirectly coupled to, for example, a random access memory (“RAM”) 130, a controller 140, and a display 150. Controller 140, which may or may not be integrated into any one of the previously described components, may be directly or indirectly coupled to a boot read-only-memory (“ROM”) 160 and TPM 110. Controller 140 may be further coupled to various embedded devices 170 and/or removable devices 180, and a trusted hard disk drive (“THDD”) 190. Boot ROM 160 may include a BIOS 160a and may also include one or more Option ROMs or platform extensions 160b. TPM 110 preferably includes one or more shielded memory locations used to protect and report integrity measurements, called platform configuration registers (“PCRs”) 110a.

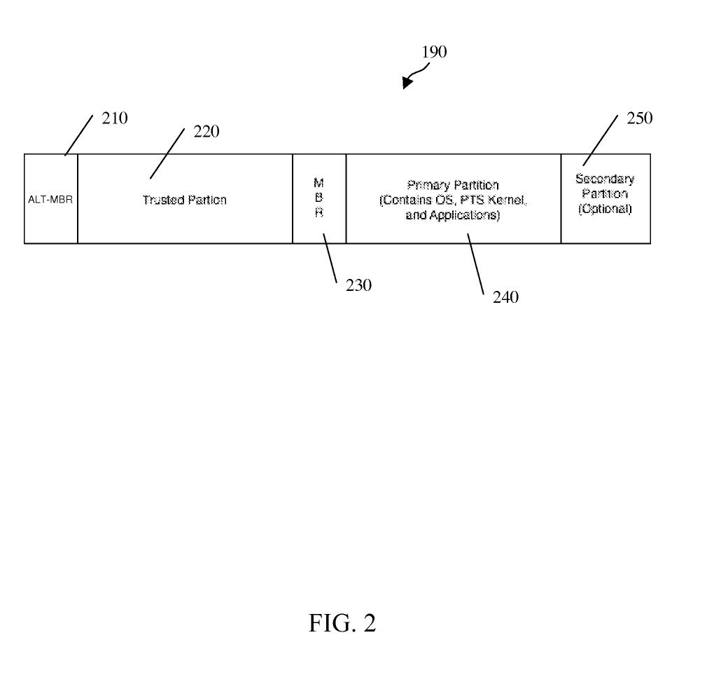

FIG. 2 is a block diagram depicting an exemplary THDD 190 in accordance with an illustrative embodiment of the present invention. The THDD preferably includes an alternate master boot record (“ALT-MBR”) 210, and a master boot record (“MBR”) 230. MBR 230 is typically the first sector of a data storage device such as a hard disk drive. MBR 230 typically holds, among other things, the disk partition table data. In accordance with an illustrative embodiment of the present invention, ALT-MBR 210 included in THDD 190 is a modified version of a normal MBR that includes additional instructions for ensuring the trustworthiness of the PC platform 100. These additional instructions allow ALT-MBR 210 to measure the MBR 230 using, thus preserving the transitive trust chain. Upon completing execution of ALT-MBR 210, the platform 100 may subsequently execute code in the MBR 230 for the purpose of booting the OS.

THDD 190 preferably includes a primary partition 240, and a trusted partition 220. THDD 190 may also include one or more additional partitions such as, for example, a secondary partition 250. Primary partition 240 may store the OS, applications and the PTS kernel.

The PTS is the trusted piece of code which will be relied upon to take measurements of executables and provide integrity reports of those measurements. An integrity report is output from the PTS that contains a TPM 100 signature over PCRs 110a and details of measurements taken by the PTS or input by applications that use the PTS. The integrity report may be used later in verifying the trustworthiness of the PC platform. The PTS kernel is that initial portion of the PTS that is measured prior to the execution of the PTS that extends the transitive trust chain to the entire PTS. Once the PTS kernel has been measured, the PTS may bootstrap itself to execute one or more portions of its code.

Trusted partition 220 may hold one or more computer programs that is accessible only during PC platform's 100 boot process and that is executed after being read from ALT-MBR 210. Upon completion of execution of the program(s) in trusted partition 220, THDD 190 preferably disables all access to trusted partition 220. This preferably occurs prior to the execution of code in primary partition 240 holding the OS.

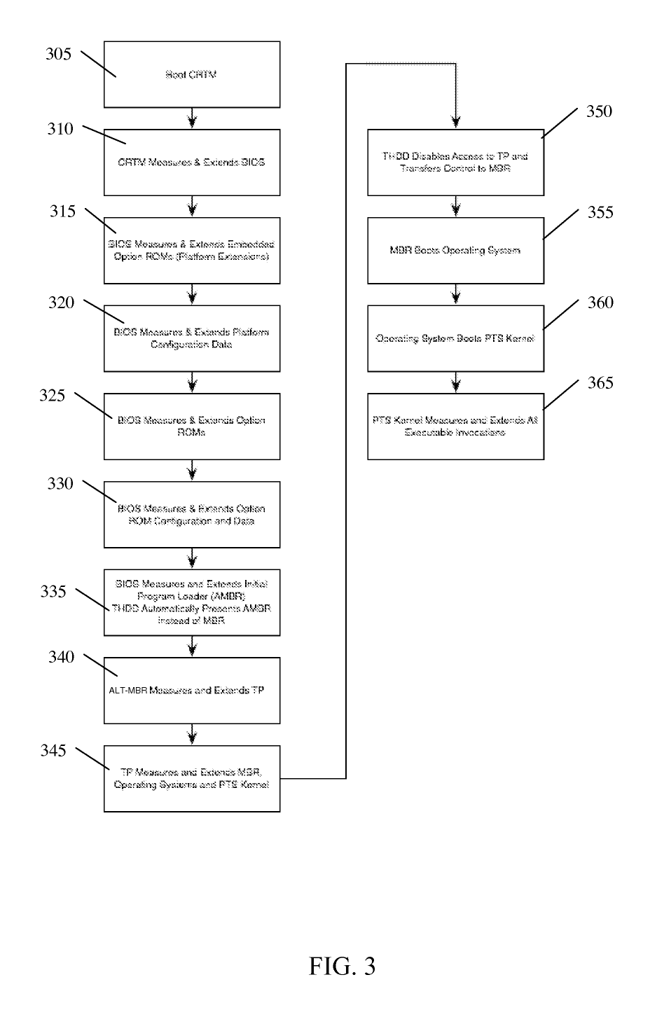

FIG. 3 is a flow chart depicting a method for verifying integrity using a THDD in accordance with an illustrative embodiment of the present invention. The verification process relies upon a transitive chain of trust. At step 305, PC platform 100 boots the CRTM, which as was previously explained is the core trusted root for measurement of integrity, i.e. trustworthiness. At step 310, CRTM “measures” PC platform's 100 BIOS 160a and extends the value of that measurement into a PCR 110a in TPM 110. As was previously noted, a measurement of any particular component may, in accordance with the present invention, be a hash digest of that component. While the measurement is preferably a hash digest, it need not be, and may instead take the form of any verifiable measurement, including encryption/decryption, digital signatures, and the like. Moreover, as an alternative embodiment, where an extensible firmware interface (“EFI”) is used instead of a conventional BIOS, the present invention may at step 310 measure the PC platform's EFI. One of ordinary skill in the art will readily appreciate that the present invention may operate on platforms utilizing EFI instead of a conventional BIOS without substantial modification.

At step 315, the boundary of trust has been extended to include BIOS 160a, and thus BIOS 160a may measure any embedded Option ROMs (i.e. platform extensions). BIOS 160a then adds (i.e. extends) the value of that measurement into a rolling hash digest stored in PCR 110a. At step 320, BIOS 160a may measure platform configuration data and extend that value into a PCR 110a as well. At step 325, BIOS 160a may further measure any additional Option ROMs, and extend that value into a PCR 110a. At step 330, BIOS 160a may then measure the option ROM configuration and data and extend that value into a PCR 110a. At step 335, BIOS 160a may measure the initial program loader and extend that value into a PCR 110a. Details of the measurements taken in steps 305 through 330 may be placed into the PC's advanced configuration and power interface (“ACPI”) tables. Any number of other intervening components during the boot process may be measured and have their values into a PCR 110a.

At step 335, to extend the boundary of trust in the transitive trust chain, THDD 190 presents ALT-MBR 210 instead of MBR 230. At step 340, the program(s) read from ALT-MBR 210 measures trusted partition 220, and extends those values into a PCR 110a. Alternatively, before the values are extended into PCR 110a, the measured value may first be compared with an expected value and certain actions may be taken if the integrity values measured do not match those expected values, which may be stored in a reference manifest. For example, if the measured and expected values do not match, then the trusted partition and/or the MBR may be marked as being potentially compromised for appropriate security action. Further, for example, if the local integrity check indicates an invalid state (or if the platform boots to an incorrect state), then access to User Data on the computer's HDD data may be denied.

Alternatively, instead of measuring the entire trusted partition 220, the program(s) loaded from ALT-MBR 210 may be used to measure a smaller, initial portion of the code in trusted partition 220, and the initial portion of the code in trusted partition 220 may be used to measure the remainder of the code in trusted partition 220. This alternative embodiment has the advantage of reducing the size of the ALT-MBR 210.

Trusted partition 220 is now within the boundary of trust, and thus at step 345 ALT-MBR 210 passes control to trusted partition 220, which in turn measures MBR 230, the entire OS, including all OS patches, and the PTS kernel in primary partition 240, and extends the value of those measurements into a PCR 110a. Details of the measurements taken in steps 335 through 345 may be recorded in the PC's ACPI tables and used by the PTS to provide details of the pre-OS measurements in an integrity report.

Alternatively, at step 345, instead of measuring the entire OS, trusted partition 220 may measure only the PTS kernel. This may improve the performance of the measurement process of the present invention, as measuring the entire OS can be time consuming. In addition, it is preferable that the PTS kernel begins execution prior to all device drivers or prior to other device drivers, if PTS is implemented as a device driver itself. There are well-known methods in the art to ensure a device driver loads early in the boot process. If there are any other device drivers designated to load early in the boot process, the program(s) loaded from trusted partition 220 preferably also measure those device drivers since the OS may not guarantee that the PTS kernel is loaded prior to other high priority device drivers.

In yet another alternative embodiment, at step 345, the present invention may measure the entire OS but not measure the PTS kernel. This embodiment may be advantageous in situations where the OS inherently contains PTS kernel functionality as part of the core OS, as it improves the performance of the measurement process at step 345.

In another alternative embodiment, at step 345, the entire OS need not be measured. Instead, only selected portions of the OS that are deemed critical to the security of the system may be measured, to improve performance during the boot process. The PTS kernel may then measure the rest of the OS (e.g. those portions of the OS that were not deemed to be security-critical) in the OS-present environment.

At step 350, THDD 190 disables access to trusted partition 220 and loads the program(s) from MBR 230 and transfers control to that program(s). At step 355, the program(s) loaded from MBR 230 boots the OS, and at step 360, the OS loads the PTS kernel. At step 365, the PTS kernel may then monitor an OS program loader. Each time the OS loads an executable, PTS kernel may take a static measurement of the file as it exists in persistent storage (such as, for example, in the hard disk drive) at step 365, and may then extend that measurement into a PCR 110a. The PTS may then take those measurements and construct an integrity report for later verification purposes.

In the alternative, at step 365, instead of monitoring the OS program loader, the OS program loader may be replaced with a modified program loader that automatically measures each executable prior to loading it. This alternative approach has the advantage that, by definition, all executables will be measured even if they are invoked prior to the execution of the PTS kernel.

In yet another alternative embodiment, at step 365, instead of monitoring the program loader, the program loader may be replaced with a modified version that automatically measures the executable program(s) prior to loading it and compares the measured value with the expected value. If the measured and expected values do not match, then an alternative path may be taken. For example, if the measured and expected values do not match, then the executable program(s), for example, may not be loaded normally, but may instead be loaded into an isolated environment with reduced system privileges. As another example, if the measured and expected values do not match, then the executable program(s) may be loaded normally only after being marked as potentially compromised. This alternative approach has the advantage that the loader has the opportunity to ensure that the integrity value of the executable program(s) exactly matched the reference manifest value prior to it being loaded.

While the previously described illustrative embodiment of the present invention focused on an SRTM model, the present invention may also be implemented in a DRTM model such as Intel's® TXT™, AMD's® SEM™, or Citrix's XEN™. For example, at step 345, instead of a measured loading of the OS, trusted partition 220 may first bootstrap into a measured loading of a hypervisor or virtual machine monitor (“VMM”). The VMM may then, for example, subsequently measure the OS that it loads and the PTS kernel that the OS loads.

As yet another alternative embodiment, an EFI may be utilized in place of a THDD in any of the steps described in FIG. 3. This alternative embodiment is useful for platforms that do not comprise a THDD, or for platforms that have a THDD but have ALT-MBR 210 and/or trusted partition 230 functionality disabled. In such a case, the EFI may be used to measure any combination of the PTS kernel, the OS, and/or any other device drivers that may execute early in the OS-present environment.

For platforms that contain a TPM 110, but have no CRTM or a disabled CRTM, trusted partition 230 may be used as an alternative to a CRTM for all OS-dependent malware. In the SRTM model, to mitigate potential threats installed prior to its execution, trusted partition 230 program(s) may take action to clear system memory, the microprocessor, and other components of the PC platform. In the DRTM model, to mitigate potential threats installed prior to its execution, trusted partition 230 program(s) may take action to invoke a dynamic reset of the system with a subsequent load of a hypervisor or secure kernel. In the SRTM model, trusted partition 230 program(s) can attempt to determine all of the program(s) executed prior to it, measure that program(s), and extend the measurements into a PCR 110a.

In an alternative embodiment of the present invention, there need not be a static one-time measurement of program(s) prior to their execution. Instead, a portion of trusted partition 230 program(s) may remain resident and executing in system memory after access to trusted partition 230 is disabled and while and after the OS has been booted. This program(s) may be used periodically to perform dynamic in-memory scans of the PTS kernel and the OS while they are executing to detect possible attacks in the OS-present environment. Similarly, EFI program(s) may continue to execute in parallel to the OS. EFI program(s) may also be used to perform in-memory scans of the PTS kernel and the OS; the scans may be of the primary OS or a virtualized guest OS.

In addition to performing transitive trust chain-based measurements and evaluations prior to the execution of the OS, the present invention has other applications for security and access control solutions. For example, using the present invention, a controlled boot may be performed whereby PC platform 100 is only permitted to boot if it is connected to an acceptable network or domain. For example, booting of the platform may only be allowed if the platform is connected to an acceptable network (i.e. boot is only allowed when connected to a trusted network) or perhaps if it is not connected to any network. This scenario assumes that trusted partition 230 is able to load a small, potentially constrained, service environment which supports a network stack for communication with the network. Only with successful identification of an approved network or domain would the program(s) from trusted partition 230 permit the platform 100 to boot the OS. This solution guarantees that platform 100 cannot be accessed when platform 100 is not connected to an acceptable network. The implementer may also choose to disable wireless login if so desired to guarantee a physical connection to the network.

Another application of the present invention may be the implementation of a controlled boot whereby platform 100 is only permitted to boot to a partition containing a constrained OS or an OS containing a trusted set of applications, if platform 100 is not connected to an acceptable network. That is, instead of denying a boot of the platform, the program(s) loaded from trusted partition 230 only allows a boot to a constrained environment. This solution guarantees that some sensitive applications or sensitive data can be accessed only if the platform is located on an acceptable network. The implementer may choose to disable wireless login, if so desired, to guarantee a physical connection to the network.

Those of ordinary skill in the art will appreciate that, for additional security, all of the embodiments of the present invention described herein may be combined with user authentication and/or platform authentication performed by, for example, program(s) loaded from trusted partition 230. Moreover, although the present invention has been described in connection with specific exemplary embodiments, it should be understood that various changes, substitutions and alterations may be made to the disclosed embodiments without departing from the spirit and scope of the invention. For example, the logic of THDD 190 described herein may be implemented in a computer platform having a conventional HDD in accordance with the principles of the present invention. In such an implementation, the HDD includes an ALT-MBR, but there is no hidden partition. The TPM PCRs are used to record events, and access control decisions may be made (e.g., by a state verifier) based on the TPM PCRs state in the same or similar manner as the implementations having a THDD with a hidden partition described herein.

We claim:

1. A method for measuring the trustworthiness of a computing platform comprising:
passing control of measurement to program(s) loaded from an alternative master boot record (“ALT-MBR”) stored on a trusted hard disk drive (“THDD”); and
measuring one or more portions of a trusted partition in the THDD using the program(s) loaded from ALT-MBR.

2. The method of claim 1, further comprising:
measuring a master boot record (“MBR”) using program(s) loaded from the trusted partition.

3. The method of claim 2, further comprising:
measuring one or more portions of an operating system of the platform using program(s) loaded from the trusted partition.

4. The method of claim 3, further comprising:
booting the operating system of the platform using the program(s) loaded from MBR.

5. The method of claim 4, further comprising:
measuring each component loaded by the operating system.

6. The method of claim 5, further comprising:
extending values of the measurement of the trusted partition into a trusted portion of the platform.

7. The method of claim 6 wherein the trusted portion of the platform is a trusted platform module.

8. The method of claim 6, further comprising:
comparing the values of the measurement of the trusted partition with an expected reference value.

9. The method of claim 8, further comprising:
measuring a platform trust service (“PTS”) kernel using program(s) loaded from the trusted partition.

10. The method of claim 3, further comprising:
bootstrapping into a measured loading of a virtual machine monitor;
measuring each component loaded by the operating system; and
measuring the PTS kernel.

11. The method of claim 3, further comprising:
comparing one or more values of the measurement of the one or more portions of the operating system with an expected reference value; and
booting the operating system.

12. A system for measuring the trustworthiness of a computing platform, comprising:
a trusted hard disk drive (“THDD”), further comprising:
a trusted partition;
a master boot record (“MBR”) and the program(s) it contains;
a primary partition and the program(s) it contains; and
an alternative master boot record (“ALT-MBR”) and the program(s) it contains that is operable to measure one or more portions of the trusted partition in the THDD using the program(s) loaded from the ALT-MBR.

13. The system of claim 12, wherein the primary partition stores at least a portion of an operating system, and a platform trust service (“PTS”) kernel.

14. The system of claim 12, wherein the trusted partition is operable to measure the program(s) contained in the MBR.

15. The system of claim 14, wherein the trusted partition is operable to measure one or more portions of an operating system of the platform.

16. The system of claim 15, wherein the computing platform further comprises a trusted portion operable to accept one or more measured values.

17. The system of claim 16, wherein the trusted portion is a trusted platform module.

18. The system of claim 17, further comprising:
a virtual machine monitor that the trusted partition is operable to measure,
wherein the virtual machine monitor is itself operable to measure one or more portions of the operating system.

19. The system of claim 18, wherein the virtual machine monitor is further operable to measure the PTS kernel.

20. A method of performing access control on a computing platform comprising:
measuring a program(s) contained in the alternative master boot record (“ALT-MBR”) stored on a trusted hard disk drive (“THDD”);
measuring one or more portions of a trusted partition in the THDD using the program(s) contained in the ALT-MBR;
comparing the values of the measurement of the trusted partition with an expected reference value to determine a level of trustworthiness; and
determining access rights on the platform based on the determined level of trustworthiness.

21. A method of performing network access control on a computing platform comprising:
measuring a program(s) contained in the alternative master boot record (“ALT-MBR”) stored on a trusted hard disk drive (“THDD”);
measuring one or more portions of a trusted partition in the THDD using the program(s) contained in the ALT-MBR;
comparing the values of the measurement of the trusted partition with an expected reference value to determine that the trusted partition is trustworthy;
determining, using the trusted partition, whether the platform is connected to a particular set of one or more computers;
permitting an operating system for the platform to boot based on whether the platform is connected to said particular set of one or more computers.

22. A method for making access control decisions for a computing platform, the computing platform including a Trusted Platform Module (“TPM”), the method comprising:
passing control of trustworthiness measurement of the computing platform to program(s) loaded from an alternative master boot record (“ALT-MBR”),
using the TPM to record trustworthiness measurements;
verifying the TPM state; and
making access control decisions for the computing platform based on the verified TPM state.

23. A system for making access control decisions for a computing platform, the computing platform including a Trusted Platform Module (“TPM”), the system comprising:
an alternative master boot record (“ALT-MBR”) having programs for trustworthiness measurement of the computing platform,
wherein the TPM is configured to record trustworthiness events;
a verifier of the TPM state; and
means for making access control decisions for the computing platform based on the verified TPM state.
